(19) United States
(12) Patent Application Publication
(10) Pub. No.: US 2023/0394608 A1
(43) Pub. Date: Dec. 7, 2023

(54) METHOD FOR AUTOMATED TRANSFER OF AN INTELLECTUAL PROPERTY PORTFOLIO

(71) Applicant: Black Hills IP Holdings, LLC, Minneapolis, MN (US)

(72) Inventor: Steven W. Lundberg, Edina, MN (US)

(21) Appl. No.: 18/205,988

(22) Filed: Jun. 5, 2023

Related U.S. Application Data
(60) Provisional application No. 63/348,873, filed on Jun. 3, 2022.

(51) Int. Cl. G06Q 50/18; G06Q 10/10

(52) U.S. Cl. CPC G06Q 50/184; G06Q 10/10

(57) ABSTRACT

Various embodiments disclosed relate to intellectual property portfolio transfer methods. The present disclosure includes a method of transferring an intellectual property portfolio including obtaining a list of documents related to a patent matter from a governmental database, scraping the documents and metadata from the governmental database, automatically producing a plurality of requirements based on the documents and the metadata, docketing the plurality of requirements to produce a dynamic docket, receiving one or more inputs regarding the plurality of requirements on the dynamic docket, and automatically recalculating the plurality of requirements on demand.

### CLAIM OF PRIORITY

This application claims the benefit of priority under 35 U.S.C. § 119(e) to U.S. Patent Application Ser. No. 63/348,873, filed on Jun. 3, 2022, which is incorporated by reference herein in its entirety.

### BACKGROUND

In a business, docketing systems can be used to track workflow deadlines, tasks, and progress. For example, in a given project, a docketing system can track when the project is opened, what initial filings are due when, and correspondence coming in regarding that project. The docketing system can additionally be used to record deadlines and flag correspondence or documents that may require a response. However, in a general docketing setting, a large number of items and tasks are incoming and often need to be sorted during docketing.

In some situations, a client may desire to transfer their intellectual property portfolio from an old law firm to a new law firm. A variety of factors can cause such a transfer. When these transfers occur, a large amount of docketing much be accomplished to complete the transfer process. In particular, a large transfer can be time consuming and require manual work to complete.

### SUMMARY OF THE DISCLOSURE

The present disclosure provides a method and system for transferring patent portfolios. When a client decides to move their work to a new law firm, their old law firm must transfer all appropriate files. This process can be lengthy and cumbersome. The old (e.g., originating) law firm may drag their feet or have a large volume of files to transfer. In this case, there may be interim deadlines associated with the files that the new law firm is unaware of.

For this reason, the methods discussed herein allow for a new (e.g., receiving) law firm to automatically obtain information for the new case files from a third-party source, such as a governmental or other third-party database. For example, if the new client provides a customer number for their cases at the USPTO, a power of attorney (POA) can be automatically produced and provided to the new client. Once the POA is executed, the receiving firm can interact with the USPTO database to scrape the relevant file information into their internal docketing system. This can allow for timely monitoring of deadlines in transferred-in cases. Once the old law firm transfers the files, they can be cross-checked.

The discussed methods and systems here have a variety of advantages, some of which are unexpected. For example, the automated and semi-automated patent docket transfer methods discussed here can help streamline the transfer process between law firms. These methods can help save time, create better efficiency, and allow for more accurate cross-checking of transferred-in dockets.

In an example, a method can include obtaining a list of documents related to a patent matter from a governmental database; scraping the documents and metadata from the governmental database; automatically producing a plurality of requirements based on the documents and the metadata; docketing the plurality of requirements to produce a dynamic docket; receiving one or more inputs regarding the plurality of requirements on the dynamic docket; and automatically recalculating the plurality of requirements on demand.

In an example, a method of transferring a patent portfolio to a law firm can include receiving a notification that a receiving firm has been added to a joint customer number associated with a new client; generating a power of attorney for the receiving firm and the new client based on the customer number; receiving the executed power of attorney from the new client; filing the executed power of attorney with a governmental agency to allow the receiving firm access to a plurality of patent filings assigned to the new client; scraping data related to the plurality of patent filings from the governmental database; and docketing the plurality of patent filings in an internal docketing system at the receiving firm.

In an example, a system for transferring a patent portfolio can include an automated or semi-automated patent docketing system having a plurality of case files; a patent portfolio transfer tool configured to produce a power of attorney, access a third-party database, and generate new case files.

In an example, a computer readable medium can include a memory and a processor, the processor configured to: generate and executing a power of attorney based on a customer number with a holder of the patent portfolio; file the power of attorney with a governmental agency to allow access to a plurality of patent filings in the patent portfolio; scrape data related to the plurality of patent filings in the patent portfolio; and docket the plurality of patent filings accordingly.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a schematic diagram of a docketing system in an example.

FIG. 2 illustrates sample third-party data sources that provide docketing data input for an automated docketing system implemented for managing patent portfolios in a sample embodiment.

FIG. 3 illustrates a schematic of a patent portfolio transfer system in an example.

FIG. 4 illustrates a method of transferring a patent portfolio in an example.

FIG. 5 illustrates a method of transferring a patent portfolio in an example.

FIG. 6 illustrates an transfer order letter in an example.

FIG. 7 illustrates a block diagram of an example computing machine upon which any one or more of the techniques or methodologies discussed herein may be implemented.

### DETAILED DESCRIPTION

The present disclosure describes, among other things, an automated or semi-automated method for transferring a patent portfolio from a first law firm to a second law firm. The methods leverage techniques including scraping of data from governmental databases to allow for efficient transfer and cross-checking of deadlines in a timely manner when a large number of files are transferred at once.

As used herein, “electronic communication” refers to an electronic message or a method of exchanging messages between people using electronic devices.

As used herein, “application” or “program” can include a program or piece of software designed and written to fulfill a particular purpose of the user, such as a database application.

As used herein, “associate” can include a partner or colleague in business or at work, either internal or external.

As used herein, “unstructured text” or “unstructured data” refers to data that is not organized in a standard format, for example, text in the body of an electronic communication.

As used herein, “structured text” or “structured data” refers to data that is organized in a standard format such that a recipient may read the data and institute an automated computing system action without human interpretation of the data.

As used herein, “scraping,” “web scraping,” “data scraping,” or “web crawling,” can refer to automatically mining or collecting data or information, such as from a database or from the internet.

As used herein, “file” or “matter” can refer to a particular project, enterprise, or undertaking being worked on by an individual or a collaborative group, planned and designed to achieve a particular aim.

As used herein, “official record,” or “file history,” can refer to data about a file or matter denoting evidence about past events or tasks within that file or matter, such as an electronic record of previous events in the file or matter. An “official record” can be stored with and maintained by an overseeing agency or organization, such as a governmental organization.

As used herein, “database,” can refer to a structured set of data, such as held in a computer or on the internet, that can be accessible in various ways.

As used herein, “portfolio” can refer to a group of patent filings, such as related patents, patent filings of common ownership, patent filings of common inventorship, or other combinations thereof.

As used herein, “transfer”, “transferring”, or “transferred” can refer to the movement of an intellectual property portfolio from one law firm to another, such as directed by a client.

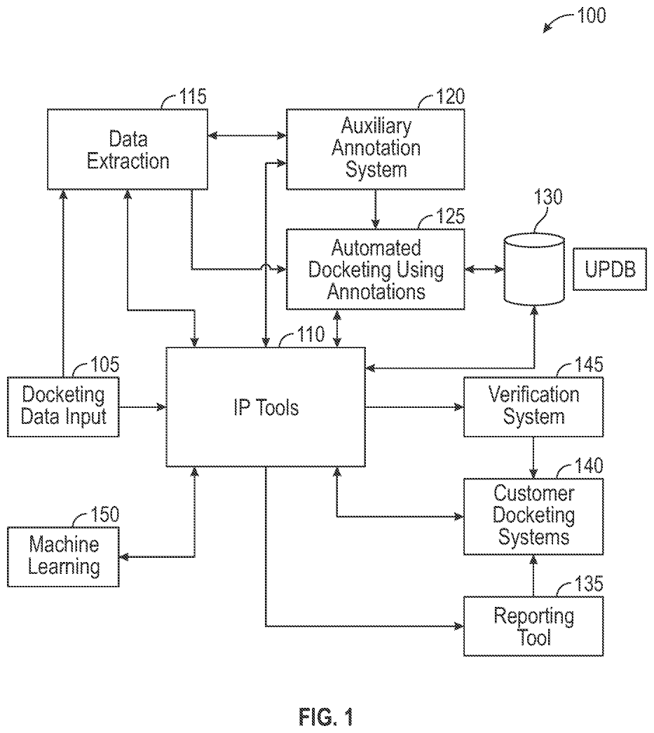

FIG. 1 is a block diagram of a docketing system 100 in an example. The docketing system 100 can be automated or semi-automated. The docketing system 100 can include docketing data input 105, docketing manager 110, data extraction 115, auxiliary annotation system 120, automated docketing using annotations 125, Universal Procedures Database 130, reporting tool 135, customer docketing system 140, verification system 145, and machine learning 150.

The automated docketing system 100 can receive documents from third-party sources including third-party docketing systems and/or customer data as docketing data input 105. The docketing manager system 110 can process the received documents to provide to the customer docketing systems 140 and prepare the documents for data extraction by the data extraction system 115 as needed.

The data extraction system 115 can perform Optical Character Recognition (OCR) on the received documents from the docketing manager system 110 to extract data, read checkboxes, extract lists, and identify documents where possible. The docketing manager system 110 can also integrate with a Universal Procedures Database (UPDB) 130 to provide automated docketing by an automated docketing tool 125 that processes received documents based on the additional annotations added to the documents based on the complex data extraction performed by the Auxiliary Annotation System (AAS) 120.

The AAS 120 may further identify the received documents without using an OCR. To manage this process, the docketing manager system 110 can receive frequent updates of docketing procedure rules including configuration data and updates the UPDB 130 with universal procedure codes (UPCs) as appropriate. The UPCs can be used in conjunction with customer specific codes, checklists, and templates. The rules can specify how to fill in the templates and how to complete customer-specific procedures such as how to docket documents into the customer's docketing system 140, for example. The template can be filled out by pulling in attributes from the annotations in a document.

The docketing manager system 110 can receive or intake documents and docketing data from several different sources of docketing data input 105, validate the docketing items against entries in a customer's docketing system 140, and communicate those documents to the customer's docketing system 140 via a unified interface. The docketing manager system 110 can also route documents and associated docketing data through the data extraction system 115 and the AAS 120 and organizes the returned metadata and annotations. The docketing manager system 110 thus can provide a breakout between the metadata and the document text.

The docketing manager system 110 can also keep records and communicate with third-party application programming interfaces (APIs) to push the docketing data and documents automatically where allowed. Otherwise, the docketing manager system 110 can present the documents to human docketers to docket. The docketing manger system 110 may also issue reports upon request.

The docketing manger system 110 can be integrated with a customer's existing docketing system (e.g., FOUNDATIONIP®), semi-integrated (e.g., CPI, ANAQUA®, etc.), may provide a virtual host that does not talk at all to the customer's existing docketing system (e.g., IP Manager, MEMOTECH™), or may provide outputs in spreadsheet form for use by a docketing administrator to update the customer's docketing system 140.

If the docketing manager system 110 and the customer's docketing system are not integrated, the data output of automated docketing system 100 may be presented to a human docketer for manual entry. For example, the human docketer may implement macros that interface with the customer's docketing system 140 to populate the received data into the customer's docketing system 140.

On the other hand, if the docketing manager system 110 and the customer's docketing system 140 are integrated or semi-integrated, the data output may be processed to determine if any data is missing to automate the docketing process. If anything is missing, the human docketer can add that information before the automated docketing process may proceed further or the data may be auto-populated and mapped to the template from the UPDB 130.

The automated docketing system 100 can also perform several post-docketing actions, such as sending docketing reports/details to an external verification system 145 that use a set of rules to verify proper docketing in a host system. The verification system 145 can verify that the data is correctly added to the external customer's docketing system 140. For example, the verification system 145 can pull data from the AAS 120, the docketing manager system 110, and the customer's docketing system 140 to compare what is present to what is expected to be present in the respective systems.

The automated docketing system 100 may also provide automated “report out” email notifications to customers by implementing a reporting tool 135 that specifies docketing actions based on UPDB template configurations. The reporting tool 135 can also provide completed docketing reports to customers either directly or via the customers' docketing system 140.

In some cases, machine learning techniques may be used to generate annotations. For example, a database of past documents that have been identified may be provided by the docketing manager system 110 and used as a data warehouse to train and improve machine learning models by creating a training set for the machine learning model. Over time, the machine learning model system 150 can learn which PTO IDs to use for which documents, which document in a bundle of documents may be used to characterize the bundle and may provide predicted PTO IDs for the received documents. The machine learning model system 150 can also establish rule engine prediction capabilities for received documents that test the classifications.

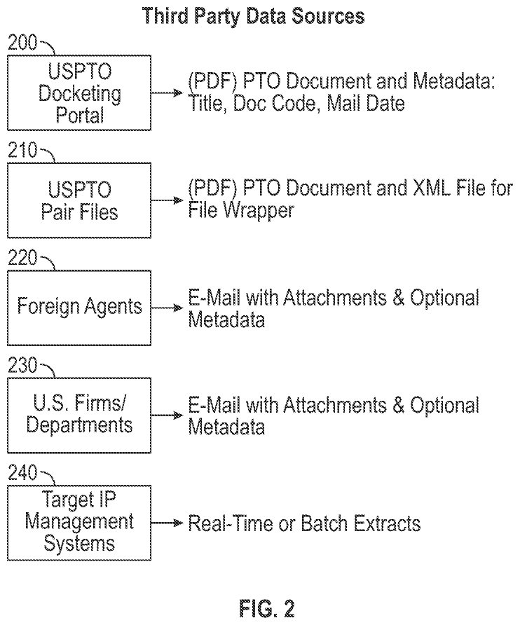

FIG. 2 illustrates sample third party data sources that provide docketing data input 105 for an automated docketing system 100 implemented for managing patent portfolios in an example. As illustrated in FIG. 2, the third-party data sources may include the Patent Office (e.g., USPTO) docketing portal 200, which provides documents from the USPTO in portable document format (PDF) and includes metadata identifying the title, document code, and mail date for the corresponding document. The third-party data sources may further include USPTO PAIR extensible markup language (XML) files 210, which provide documents from the USPTO in PDF format and includes an XML file for patent file wrappers. The third-party data sources may also include foreign agents 220 who provide emails with attachments and optional metadata.

Foreign agents 220 may also provide hard copy documents that may be scanned for data entry. Similarly, law firms and/or corporate law departments 230 may provide emails with attachments and optional metadata as well as hard copy documents that may be scanned for data entry. Also, third party docketing systems 240 may provide real-time or batch extracts of data for entry into a docketing management system.

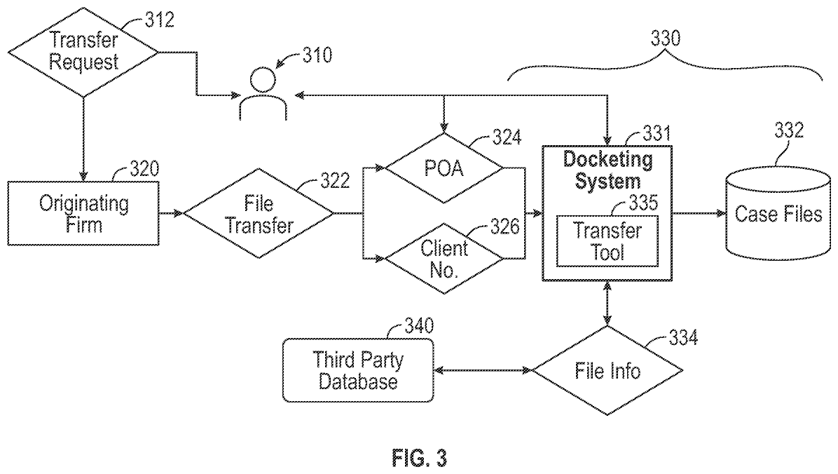

FIG. 3 illustrates a schematic of a system 300 in an example. The client 310 and the originating firm 320 can interact with the system 300 at the receiving firm 330, which can include an internal firm docketing system 331 with transfer tool 335, case files 332, and file information 334, and can interact with a third-party database 340. The client 310 can interact with the originating firm 320 through a transfer request 312. The originating firm 320 can interact with the receiving firm through the file transfer 322, including regarding a power of attorney 324 and client customer number 326.

The client 310 can be, for example, a customer such as a corporation or other organization, that desires to transfer at least a portion of its intellectual property portfolio from the originating firm 320 to the receiving firm 330. The originating firm 320 can be the legal firm currently handling this portion of the intellectual property portfolio. The client 310 can initiate a transfer request 312, asking the originating firm 320 to move the desired intellectual property portfolio to the receiving firm 330. The receiving firm 330 can be a different entity, such as a private practice firm, to which the client 310 wishes to transfer at least a portion of their intellectual property portfolio.

The receiving firm 330 can have an internal firm docketing system 331, which can include or work with the patent portfolio transfer tool 335. The internal firm docketing system 331 can be an automated or semi-automated patent docketing system having a plurality of case files 332. The internal firm docketing system 331 can be configured to receive and docket the new case files generated by the patent portfolio transfer tool 335. The internal firm docketing system 331 can, for example, be similar to the docketing system discussed with reference to FIG. 1 above.

The transfer tool 335 can be a portion of the internal docketing system 331 or can be a stand-alone program that can work with the internal docketing system 331. The transfer tool 335 can be configurable for receiving transferred-in cases and automatically, or semi-automatically, get the new transferred-in cases set up in the receiving firm's internal docketing system 331. Specifically, the transfer tool 335 can be configured to produce a power of attorney, access a third-party database, and generate new case files. The transfer tool 335 can additionally be actuatable for scraping the third-party database to produce the new case files.

For example, the transfer tool 335 can receive a list from the originating firm 320 of files to be transferred in. Using information such as file numbers, the transfer tool 335 can produce a power of attorney for the client 310 to execute. Meanwhile, the transfer tool 335 can receive a list of file numbers from the originating firm 320 and use file information 334 to scrape transferred files information from a third-party database 340 to automatically docket items into the internal firm docketing system 331.

For example, the transfer tool 335 can locate a particular file in the third-party database 340 that the client 310 desires to transfer, and scrape data from the database into the internal docketing system 331. In this case, the system can compare scraped data from the database to data provided by the originating firm 320, and flag new events or items that have appeared. For example, where an international search report is issued in the WIPO database, the transfer tool 335 can scrape the international search report and appropriate biographic data and provide this to the internal docketing system 331.

Sometimes, the transfer tool 335 may be able to scrape and transfer file information quicker than the originating firm 320 will provide transfer information. For this reason, the use of file numbers to look up public information regarding transferring-in files can be useful to prevent missing deadlines.

However, the use of the public third-party database 340 for scraping can be incomplete. For this reason, the client 310 and the originating firm 320 can provide a power of attorney 324, conferring the use of a customer number to the receiving firm. This power of attorney 324 can allow the receiving firm 330 to fully access a governmental database, enhancing the information, documents, and deadlines that can be scraped and docketed in an efficient manner.

Nonetheless, the originating firm 320 may drag their feet on providing information including the power of attorney 324 and the file information 334. In this case, particularly in the USPTO, the receiving firm 330, in addition to the file information 334, can request addition to a client customer number 326 associated with the client 310. In this case, once the receiving firm 330 has been added to the client customer number 326, the receiving firm 330 can have full, easy access to the files being transferred in, at a quicker rate than they would if waiting on the originating firm 320. This can help the receiving firm 330 to see and flag deadlines that would otherwise be missed during the transfer period.

In practice, the transfer tool 335 can include a user interface for interaction with a user. While a large amount of the transfer tool 335 actions can be automated in order to streamline transfers, user input and review may be desired. In this case, a user interface can be presented for the transfer tool 335 to allow user selections and review. In some cases, such a user interface may be available to the receiving firm 330. In some cases, such a user interface, or a variant thereon, may be available to the originating firm 320.

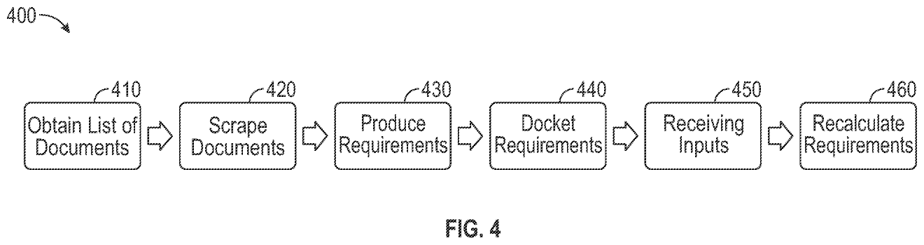

FIG. 4 illustrates a method 400 of transferring a patent portfolio in an example. The method can include blocks 410 to 460.

First, a transfer tool at a receiving firm can obtain a list of documents related to a patent matter from a governmental database (block 410). For example, the transfer tool can receive an identification number denoting a patent matter for transfer. Using that matter identification number, the receiving firm can look up the matter on a governmental database. In some cases, the matter identification number can be a customer number, such as at the USPTO. The number can allow for identification and access of information related to that transferring file.

The transfer tool can scrape the list of documents related to the patent matter from the database (block 420). In some cases, the transfer tool can scrape a list of documents from a third party. Scraping the documents can include metadata related to that transferring file. Related documents can include, for example, office actions, notifications, correspondences, or others. The transfer tool can then automatically produce a plurality of requirements based on the documents and the metadata that have been scraped (block 430). The plurality of requirements can include tasks, responses, documents, deadlines, and combinations thereof.

Subsequently, the transfer tool can move this information to the internal docketing system, where the plurality of documents can be docketed (block 440). This can produce a dynamic docket. In this case, each of the documents scraped by the transfer tool can be processed one by one, sequentially, by the internal docketing system. The internal docketing system can begin with the oldest item and work its way through the list. This can include identifying requirements that have been completed and removing completed requirements from the docket. For example, the internal docketing system may identify a non-final rejection at an earlier date, followed by a response to the non-final rejection at a later date. In this case, the internal docketing system can mark the response to non-final rejection complete as it moves sequentially through the list.

The transfer tool can receive one or more inputs regarding the plurality of requirements on the dynamic docket (block 450). Receiving one or more inputs can include, for example, receiving an input from a user, if manual review indicates that outside inputs are required. Receiving one or more inputs can include, for example, receiving a scheduled input, such as a monthly audit. The transfer tool can automatically recalculate the plurality of requirements on demand, based on the inputs (block 460). This can allow for cross-checking the plurality of requirements based on the documents and the metadata.

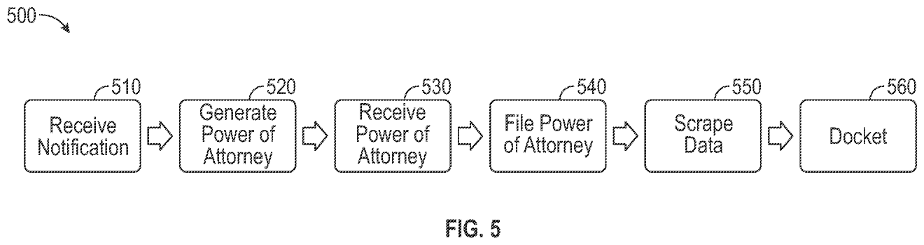

FIG. 5 illustrates a method 500 of transferring a patent portfolio in an example. The method 500 can include blocks 510 to 560.

At block 510, the receiving firm can be added to a joint customer number associated with a new client. The receiving firm can also receive a transfer file from an originating law firm. At block 520, a power of attorney can be generated for the receiving firm and the new client based on the customer number. The customer number can be associated with each of the plurality of patent filings.

At block 530, the receiving firm can receive the executed power of attorney from the new client. The power of attorney can confer sponsorship to the receiving firm within a governmental agency based on the customer number. At block 540, the executed power of attorney can be filed with a governmental agency to allow the receiving firm access to a plurality of patent filings assigned to the new client.

At block 550, data related to the plurality of patent filings can be scraped from the governmental database. Scraping data related to the plurality of patent filings can include collecting documents and deadlines from a third-party database maintained by the governmental agency.

Finally, at block 560, the plurality of patent filings can be docketed in an internal docketing system at the receiving firm. Docketing the plurality of patent filings can include uploading file histories of each of the plurality of patent filings in an automated or semi-automated docketing system. In some cases, docketing the plurality of patent filings can include uploading deadlines of each of the plurality of patent filings in an automated or semi-automated docketing system.

In some cases, deadlines can be flagged that occur during the transfer period. In some cases, additional cross-checking of the transfer file against the plurality of patent filings that were docketed can occur.

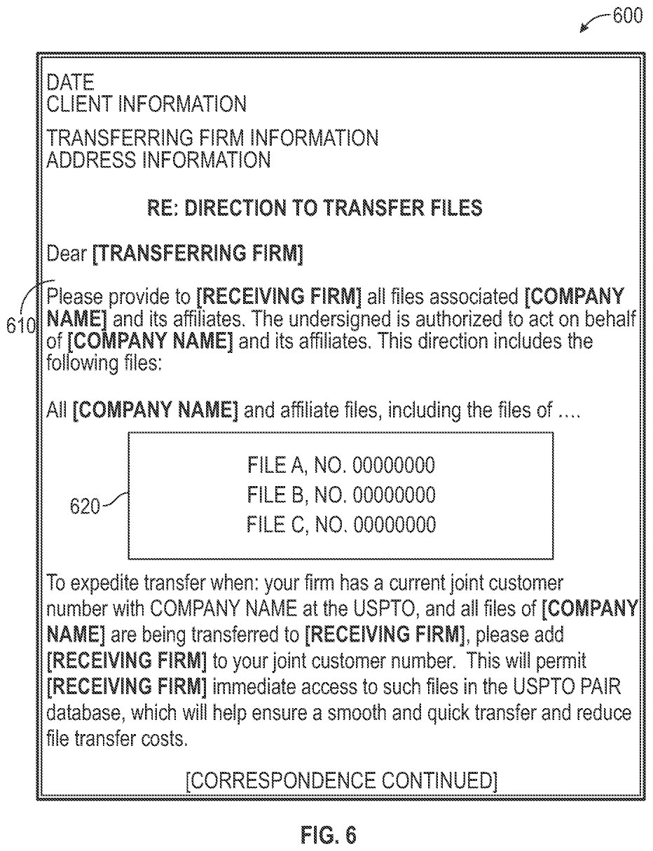

FIG. 6 illustrates a transfer order letter 600 in an example. The order letter 600 can include a letter field 610 and a file list field 620. The letter field 610 can, for example, include a request from a receiving firm to an originating firm regarding transfer of a client's files. The request can specify the desire to execute a power of attorney and add the receiving firm to a joint customer number to allow full access to the desired files. The file list field 620 can list those files, as decided by the client in their original request for transfer.

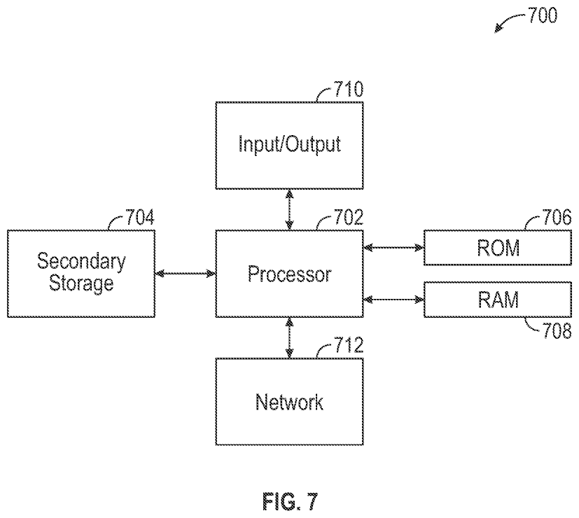

FIG. 7 illustrates a block diagram of an example computing system machine 700 upon which any one or more of the techniques (e.g., methodologies) discussed herein may perform. Machine 700 (e.g., computer system) may include a hardware processor 702 (e.g., a central processing unit [CPU], a graphics processing unit [GPU], a hardware processor core, or any combination thereof), a main memory 704 and a static memory 706, connected via an interconnect 708 (e.g., link or bus), as some or all of these components may constitute hardware for systems 100 or 200 or hardware to operate the services and subsystems and related implementations discussed above.

Specific examples of main memory 704 include Random Access Memory (RAM), and semiconductor memory devices, which may include, in some embodiments, storage locations in semiconductors such as registers. Specific examples of static memory 706 include non-volatile memory, such as semiconductor memory devices (e.g., Electrically Programmable Read-Only Memory [EPROM], Electrically Erasable Programmable Read-Only Memory [EEPROM]) and flash memory devices; magnetic disks, such as internal hard disks and removable disks; magneto-optical disks; RAM; and CD-ROM and DVD-ROM disks.

The machine 700 may further include a display device 710, an input device 712 (e.g., a keyboard), and a user interface (UI) navigation device 714 (e.g., a mouse). In an example, the display device 710, input device 712 and UI navigation device 714 may be a touch screen display. The machine 700 may additionally include a mass storage device 716 (e.g., drive unit), a signal generation device 718 (e.g., a speaker), a network interface device 720, and one or more sensors 730, such as a global positioning system (GPS) sensor, compass, accelerometer, or some other sensor. The machine 700 may include an output controller 728, such as a serial (e.g., universal serial bus (USB), parallel, or other wired or wireless (e.g., infrared [IR], near field communication [NFC], etc.) connection to communicate or control one or more peripheral devices (e.g., a printer, card reader, etc.). In some embodiments the hardware processor 702 and/or instructions 724 may comprise processing circuitry and/or transceiver circuitry.

The mass storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the mass storage device 716 constitutes, in at least some embodiments, machine readable media.

The term “machine readable medium” includes, in some embodiments, any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Specific examples of machine readable media include, one or more of non-volatile memory, such as semiconductor memory devices (e.g., Electrically Programmable Read-Only Memory [EPROM], Electrically Erasable Programmable Read-Only Memory [EEPROM]) and flash memory devices; magnetic disks, such as internal hard disks and removable disks; magneto-optical disks; RAM; and CD-ROM and DVD-ROM disks. While the machine readable medium 722 is illustrated as a single medium, the term “machine readable medium” includes, in at least some embodiments, a single medium or multiple media (e.g., a centralized or distributed database, and/or associated caches and servers) configured to store the one or more instructions 724. In some examples, machine readable media includes non-transitory machine readable media. In some examples, machine readable media includes machine readable media that is not a transitory propagating signal.

The instructions 724 are further transmitted or received, in at least some embodiments, over a communications network 726 using a transmission medium via the network interface device 720 utilizing any one of a number of transfer protocols (e.g., frame relay, internet protocol [IP], transmission control protocol [TCP], user datagram protocol [UDP], hypertext transfer protocol [HTTP], etc.). Example communication networks include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.15.4 family of standards, a Long Term Evolution (LTE) 4G or 5G family of standards, a Universal Mobile Telecommunications System (UMTS) family of standards, peer-to-peer (P2P) networks, and satellite communication networks, among others).

An apparatus of the machine 700 includes, in at least some embodiments, one or more of a hardware processor 702 (e.g., a central processing unit [CPU], a graphics processing unit [GPU], a hardware processor core, or any combination thereof), a main memory 704, a static memory 706, sensors 730, network interface device 720, antennas 732, a display device 710, an input device 712, a UI navigation device 714, a mass storage device 716, instructions 724, a signal generation device 718, and an output controller 728. The apparatus is configured, in at least some embodiments, to perform one or more of the methods and/or operations disclosed herein. The apparatus is, in some examples, a component of the machine 700 to perform one or more of the methods and/or operations disclosed herein, and/or to perform a portion of one or more of the methods and/or operations disclosed herein.

In an example embodiment, the network interface device 720 includes one or more physical jacks (e.g., Ethernet, coaxial, or phone jacks) or one or more antennas to connect to the communications network 726. In an example embodiment, the network interface device 720 includes one or more antennas 732 to wirelessly communicate using at least one of single-input multiple-output (SIMO), multiple-input multiple-output (MIMO), or multiple-input single-output (MISO) techniques. In some examples, the network interface device 720 wirelessly communicates using Multiple User MIMO techniques. The term “transmission medium” shall be taken to include any intangible medium that is capable of storing, encoding or carrying instructions for execution by the machine 700, and includes digital or analog communications signals or other intangible media to facilitate communication of such software.

At least some example embodiments, as described herein, include, or operate on, logic or a number of components, modules, or mechanisms. Such components are tangible entities (e.g., hardware) capable of performing specified operations and are configured or arranged in a certain manner. In an example, circuits are arranged (e.g., internally or with respect to external entities such as other circuits) in a specified manner as a module. In an example, the whole or part of one or more computer systems (e.g., a standalone, client or server computer system) or one or more hardware processors are configured by firmware or software (e.g., instructions, an application portion, or an application) as a component that operates to perform specified operations. In an example, the software resides on a machine readable medium. In an example, the software, when executed by the underlying hardware of the component, causes the hardware to perform the specified operations.

Accordingly, such components are understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which components are temporarily configured, each of the modules need not be instantiated at any one moment in time. For example, where the components comprise a general-purpose hardware processor configured using software, in some embodiments, the general-purpose hardware processor is configured as respective different components at different times. Software accordingly configures a hardware processor, for example, to constitute a particular component at one instance of time and to constitute a different component at a different instance of time.

Some embodiments are implemented fully or partially in software and/or firmware. This software and/or firmware takes the form of instructions contained in or on a non-transitory computer-readable storage medium, in at least some embodiments. Those instructions are then read and executed by one or more hardware processors to enable performance of the operations described herein, in at least some embodiments. The instructions are in any suitable form, such as but not limited to source code, compiled code, interpreted code, executable code, static code, dynamic code, and the like. Such a computer-readable medium includes any tangible non-transitory medium for storing information in a form readable by one or more computers, such as, but not limited to, read only memory (ROM); random access memory (RAM); magnetic disk storage media; optical storage media; flash memory, etc. Various embodiments may be implemented fully or partially in software and/or firmware. This software and/or firmware may take the form of instructions contained in or on a non-transitory computer-readable storage medium. Those instructions are then read and executed by one or more processors to enable performance of the operations described herein. The instructions are in any suitable form, such as, but not limited to, source code, compiled code, interpreted code, executable code, static code, dynamic code, and the like. Such a computer-readable medium includes, in at least some embodiments, any tangible non-transitory medium for storing information in a form readable by one or more computers, such as, but not limited to, read only memory (ROM); random access memory (RAM); magnetic disk storage media; optical storage media; flash memory, etc.

### Various Notes & Examples

Example 1 is a method comprising: obtaining a list of documents related to a patent matter from a governmental database; scraping the documents and metadata from the governmental database; automatically producing a plurality of requirements based on the documents and the metadata; docketing the plurality of requirements to produce a dynamic docket; receiving one or more inputs regarding the plurality of requirements on the dynamic docket; and automatically recalculating the plurality of requirements on demand.

In Example 2, the subject matter of Example 1 optionally includes wherein the plurality of requirements includes tasks, responses, documents, deadlines, and combinations thereof.

In Example 3, the subject matter of any one or more of Examples 1-2 optionally includes receiving a matter identification number denoting the patent matter prior to obtaining the list of documents related to the patent matter.

In Example 4, the subject matter of Example 3 optionally includes wherein the matter identification number comprises a customer number.

In Example 5, the subject matter of any one or more of Examples 1-4 optionally includes wherein obtaining the list of documents related to the patent matter comprises scraping the list of documents from a database.

In Example 6, the subject matter of any one or more of Examples 1-5 optionally includes wherein obtaining the list of documents related to the patent matter comprises scraping the list of documents from a third party.

In Example 7, the subject matter of any one or more of Examples 1-6 optionally includes wherein receiving one or more inputs comprises receiving an input from a user.

In Example 8, the subject matter of any one or more of Examples 1-7 optionally includes wherein receiving one or more inputs comprises receiving a scheduled input.

In Example 9, the subject matter of any one or more of Examples 1-8 optionally includes wherein the documents comprise office actions, notifications, or correspondences.

In Example 10, the subject matter of any one or more of Examples 1-9 optionally includes cross-checking the plurality of requirements based on the documents and the metadata.

In Example 11, the subject matter of any one or more of Examples 1-10 optionally includes where docketing the plurality of requirements to produce a dynamic docket comprises automatically processing each of the documents sequentially.

In Example 12, the subject matter of Example 11 optionally includes where docketing the plurality of requirements to produce a dynamic docket further comprises identifying requirements that have been completed and removing completed requirements from the docket.

Example 13 is a method of transferring a patent portfolio to a law firm, the method comprising: receiving a notification that a receiving firm has been added to a joint customer number associated with a new client; generating a power of attorney for the receiving firm and the new client based on the customer number; receiving the executed power of attorney from the new client; filing the executed power of attorney with a governmental agency to allow the receiving firm access to a plurality of patent filings assigned to the new client; scraping data related to the plurality of patent filings from the governmental database; and docketing the plurality of patent filings in an internal docketing system at the receiving firm.

In Example 14, the subject matter of Example 13 optionally includes wherein the customer number is associated with each of the plurality of patent filings.

In Example 15, the subject matter of any one or more of Examples 13-14 optionally includes wherein scraping data related to the plurality of patent filings comprises collecting documents and deadlines from a third-party database maintained by the governmental agency.

In Example 16, the subject matter of any one or more of Examples 13-15 optionally includes wherein the power of attorney confers sponsorship to the receiving firm within the governmental agency.

In Example 17, the subject matter of any one or more of Examples 13-16 optionally includes wherein docketing the plurality of patent filings comprises uploading file histories of each of the plurality of patent filings in an automated or semi-automated docketing system.

In Example 18, the subject matter of any one or more of Examples 13-17 optionally includes wherein docketing the plurality of patent filings comprises uploading deadlines of each of the plurality of patent filings in an automated or semi-automated docketing system.

In Example 19, the subject matter of Example 18 optionally includes flagging deadlines that occur during a transfer period.

In Example 20, the subject matter of any one or more of Examples 13-19 optionally includes receiving a transfer file from an originating law firm.

In Example 21, the subject matter of Example 20 optionally includes cross-checking the transfer file against the plurality of patent filings that were docketed.

Example 22 is a system for transferring a patent portfolio, the system comprising: an automated or semi-automated patent docketing system having a plurality of case files; a patent portfolio transfer tool configured to produce a power of attorney, access a third-party database, and generate new case files.

In Example 23, the subject matter of Example 22 optionally includes a user interface configured for client access to the patent portfolio transfer tool.

In Example 24, the subject matter of any one or more of Examples 22-23 optionally includes a user interface configured for originating firm access to the patent portfolio transfer tool.

In Example 25, the subject matter of any one or more of Examples 22-24 optionally includes wherein the automated or semi-automated patent docketing system is configured to receive and docket the new case files generated by the patent portfolio transfer tool.

In Example 26, the subject matter of any one or more of Examples 22-25 optionally includes wherein the patent portfolio transfer tool is actuatable for scraping the third-party database to produce the new case files.

Example 27 is a computer readable medium comprising a memory and a processor, the processor configured to: generate and execute a power of attorney based on a customer number with a holder of the patent portfolio; file the power of attorney with a governmental agency to allow access to a plurality of patent filings in the patent portfolio; scrape data related to the plurality of patent filings in the patent portfolio; and docket the plurality of patent filings accordingly.

In Example 28, the subject matter of Example 27 optionally includes the processor further configured to receive the customer number associated from the holder of the patent portfolio.

In Example 29, the subject matter of any one or more of Examples 27-28 optionally includes the processor further configured to flag deadlines that occur during a transfer.

In Example 31, the subject matter of any one or more of Examples 27-29 optionally includes the processor further configured to receive a transfer file from an originating law firm.

In Example 31, the subject matter of any one or more of Examples 27-30 optionally includes the processor further configured to cross-check the transfer file against the plurality of patent filings that were docketed.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A method comprising:
obtaining a list of documents related to a patent matter from a governmental database;
scraping the documents and metadata from the governmental database;
automatically producing a plurality of requirements based on the documents and the metadata;
cross-checking the plurality of requirements based on the documents and the metadata;
docketing the plurality of requirements to produce a dynamic docket; where docketing the plurality of requirements to produce a dynamic docket comprises automatically processing each of the documents sequentially;
receiving one or more inputs regarding the plurality of requirements on the dynamic docket; and
automatically recalculating the plurality of requirements on demand.

2. The method of claim 1, wherein the plurality of requirements includes tasks, responses, documents, deadlines, and combinations thereof.

3. The method of claim 1, further comprising receiving a matter identification number denoting the patent matter prior to obtaining the list of documents related to the patent matter, wherein the matter identification number comprises a customer number.

4. The method of claim 1, wherein obtaining the list of documents related to the patent matter comprises scraping the list of documents from a database or a third party.

5. The method of claim 1, wherein receiving one or more inputs comprises receiving an input from a user or a scheduled input.

6. The method of claim 1, wherein the documents comprise office actions, notifications, or correspondences.

7. The method of claim 1, where docketing the plurality of requirements to produce a dynamic docket further comprises identifying requirements that have been completed and removing completed requirements from the docket.

8. A method of transferring a patent portfolio to a law firm, the method comprising:
receiving a notification that a receiving firm has been added to a joint customer number associated with a new client;
generating a power of attorney for the receiving firm and the new client based on a customer number;
receiving the executed power of attorney from the new client;
filing the executed power of attorney with a governmental agency to allow the receiving firm access to a plurality of patent filings assigned to the new client;
scraping data related to the plurality of patent filings from the governmental database, wherein scraping data related to the plurality of patent filings comprises collecting documents and deadlines from a third-party database maintained by the governmental agency; and
docketing the plurality of patent filings in an internal docketing system at the receiving firm.

9. The method of claim 8, wherein the customer number is associated with each of the plurality of patent filings.

10. The method of claim 8, wherein the power of attorney confers sponsorship to the receiving firm within the governmental agency.

11. The method of claim 8, wherein docketing the plurality of patent filings comprises uploading file histories of each of the plurality of patent filings in an automated or semi-automated docketing system.

12. The method of claim 8, wherein docketing the plurality of patent filings comprises uploading deadlines of each of the plurality of patent filings in an automated or semi-automated docketing system.

13. The method of claim 12, further comprising flagging deadlines that occur during a transfer period.

14. The method of claim 8, further comprising receiving a transfer file from an originating law firm and cross-checking the transfer file against the plurality of patent filings that were docketed.

15. A system for transferring a patent portfolio, the system comprising:
an automated or semi-automated patent docketing system having a plurality of case files;
a patent portfolio transfer tool configured to produce a power of attorney, access a third-party database, and generate new case files;
a user interface configured for client access to the patent portfolio transfer tool; and
a user interface configured for originating firm access to the patent portfolio transfer tool.

16. The system of claim 15, wherein the automated or semi-automated patent docketing system is configured to receive and docket the new case filed generated by the patent portfolio transfer tool.

17. The system of claim 15, wherein the patent portfolio transfer tool is actuatable for scraping the third-party database to produce the new case files.

18. A computer readable medium comprising a memory and a processor, the processor configured to:
receive the customer number associated from a holder of a patent portfolio;
generate and executing a power of attorney based on the customer number associated from the holder of the patent portfolio;
file the power of attorney with a governmental agency to allow access to a plurality of patent filings in the patent portfolio;
scrape data related to the plurality of patent filings in the patent portfolio;
flag deadlines that occur during a transfer period; and
docket the plurality of patent filings accordingly.

19. The computer readable medium of claim 18, the processor further configured to receive a transfer file from an originating law firm.

20. The computer readable medium of claim 18, the processor further configured to cross-check the transfer file against the plurality of patent filings that were docketed.
